(19) United States
(12) Patent Application Publication
(10) Pub. No.: US 2004/0207220 A1
(43) Pub. Date: Oct. 21, 2004

(54) Lightweight wire carrier

(75) Inventors: Andy Adams, Hartwell, GA (US); Lee Adams, Hartwell, GA (US); Ron Carpenter, Hartwell, GA (US); David McEvoy, Iva, SC (US); David Simons, Toccoa, GA (US)

Correspondence Address: KRAMER & AMADO, P.C., 2001 JEFFERSON DAVIS HWY, SUITE 1101, ARLINGTON, VA, 22202, US

(73) Assignee: Fabritex, Inc., Hartwell, GA (US)

(21) Appl. No.: 10/417,118

(22) Filed: Apr. 17, 2003

(51) Int. Cl. B66C 1/62

(52) U.S. Cl. 294/67.1

(57) ABSTRACT

A lightweight wire carrier made up of multiple components including a sectional or integral base, a vertical area and a top section. The components are joined together to allow the use of lighter and thinner materials while still retaining the requirements of existing tubular carriers.

### BACKGROUND OF THE INVENTION

1. Field of the Invention

This invention relates generally to carriers for the storage, process or transport of coiled or wound material such as wire, rod, strip metal, cable or other analogous products.

2. Description of Related Art

Wire carriers are commonly used to store, process or transport coiled or wound materials, such as wire, rod, strip metal, cable and many other analogous types of products. These carriers are often used to transport products from a producer, such as a Wire Mill, to an end user. The end users in turn utilize these products in their manufacturing processes. Generally, wire carriers are made so that they nest onto each other in order to reduce per-unit transport cost. Once wire carriers reach the end user they may be returned to the original producer at additional cost, may be stored on site or are scrapped by the end user at their own facility.

Wire carriers generally have been manufactured out of heavy gage metal tube that has been bent and formed to customer specification based on the size and weight of the load they will carry. The manufacturing and formation of wire carriers usually consists of constructing a tubular base with separate tubular vertical uprights that are notched to fit into each other and the tubular base. These separate elements are then welded together to form the wire carrier. These tubular carriers require specialized equipment to bend and notch the tubing before they are mig-welded together. The use of metal tubing results in tubular carriers that are heavy for the volume of space they occupy, requiring additional equipment to manage the weight of the carriers.

Once the tubular wire carriers leave the factory, they continue to incur increased costs for the producer and end user. The large size and heavy weight of the tubular carriers limits the number of carriers that nest onto each other and increases total volume leading to greater shipping costs. Due to the expensive manufacturing requirements, tubular carriers are often shipped back the producer, incurring additional shipping costs for the end user. If the end user chooses to scrap the tubular carrier, the tubular nature of the material requires a great deal of processing to reduce the metal to the smallest possible pieces of scrap in order to maximize the weight and value of scrap containers.

Therefore, there is a need for a design of a low cost wire carrier that allows a more economical manufacturing process, is lighter in weight and takes up less volume, is easily reduced to scrap by the end user, and can achieve a wide range of specifications to meet industry requirements while still being able to carry the same weight as a traditional tubular wire carrier.

### SUMMARY OF THE INVENTION

In light of the present need for a lightweight wire carrier, a brief summary of the present invention is presented. Some simplifications and omission may be made in the following summary, which is intended to highlight and introduce some aspects of the present invention, but not to limit its scope. Detailed descriptions of a preferred exemplary embodiment adequate to allow those of ordinary skill in the art to make and use the invention concepts will follow in later sections.

The present invention involves the design of a lightweight wire carrier that minimizes the volume, weight, and cost of the carrier while retaining weight capacity required by the manufacturing industry. More particularly the present invention allows a thin, relatively lightweight material, such as high tensile rod to be used to construct a wire carrier while still being able to maintain a weight capacity of up to around 3,000 lbs. The design includes a sectional or integral base, a vertical area and a top section that are joined together to allow the use of lighter and thinner materials while still retaining the requirements of existing tubular carriers.

### BRIEF DESCRIPTION OF THE DRAWINGS

In order to better understand the present invention, reference is made to the accompanying drawings, wherein:

FIG. 1 shows a perspective view of a carrier.

FIG. 2 shows a perspective view of the individual components that make up the carrier of FIG. 1.

FIG. 3 shows an exploded view of the placement of the components that make up the carrier of FIG. 1.

FIG. 4 shows a perspective view of the carrier of FIG. 1 detailing the joining of the assembled components.

FIG. 5 shows a perspective view of another carrier.

FIG. 6 shows a perspective view of the individual components that make up the carrier of FIG. 5.

FIG. 7 shows an exploded view of the placement of the components that make up the carrier of FIG. 5.

FIG. 8 shows a perspective view of the carrier of FIG. 5 detailing the joining of the assembled components.

### DETAILED DESCRIPTION OF THE PREFERRED EMBODIMENTS OF THE INVENTION

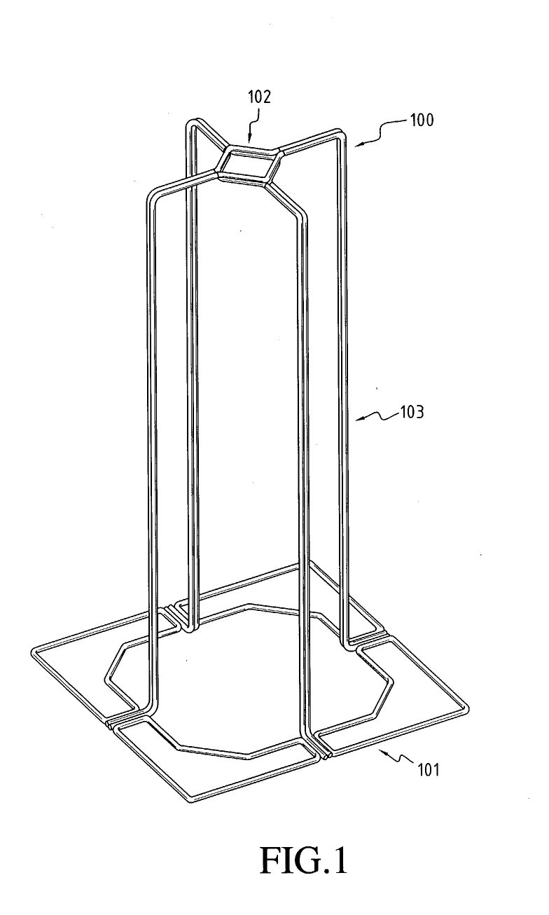

Referring now to the drawings, in which like numerals refer to like components or steps, there are disclosed broad aspects of the preferred embodiments of the present invention. FIG. 1 shows a carrier 100 according to one embodiment of the present invention. The carrier includes a sectional base 101 for placement of the carrier on a flat, substantially horizontal surface, and a top section 102. The vertical area 103 of the carrier is located between the base 101 and top section 102. The carrier may be formed of any number of suitable lightweight materials, however the most preferred material is high tensile rod.

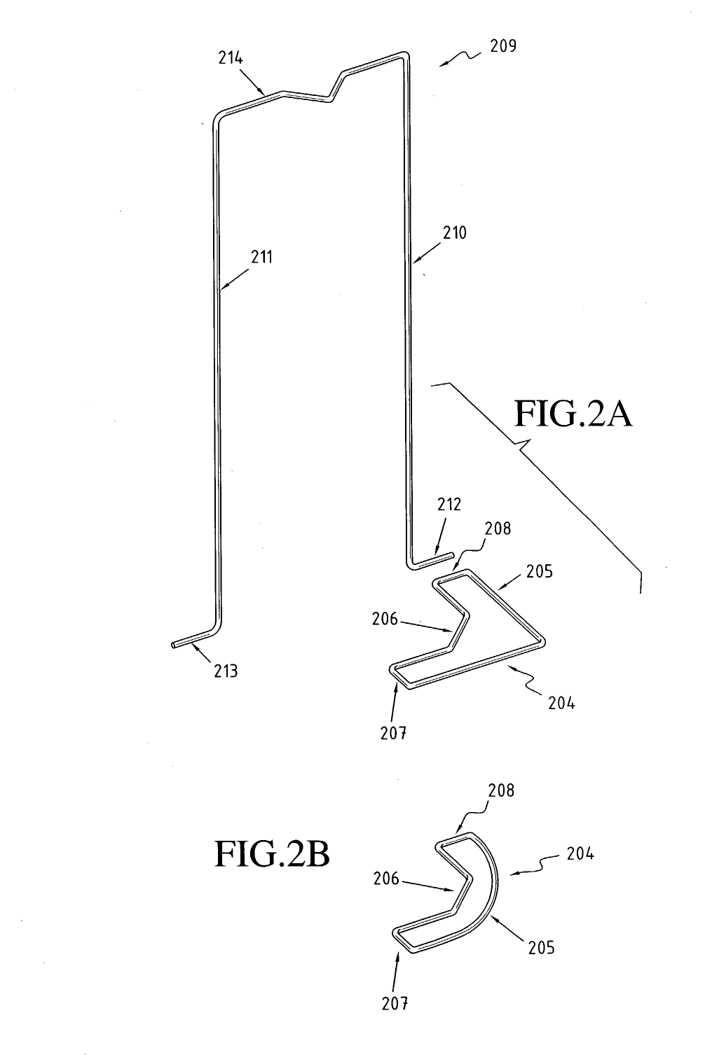

FIG. 2 shows one embodiment of the different components that may be used to construct the carrier. The sectional base is formed from a plurality of sectional independent segments 204, which may be identical or similar in shape. Each base segment 204 is characterized by an outer edge 205, an internal edge 206 and two adjoining ends 207, 208. The outer edge 205 may form a right angle (FIG. 2A) or have varying curvature (FIG. 2B) from one end 207 of a base segment 204 to the other end 208. The internal edge 206 may also be characterized by a number of different designs. In the preferred embodiment, the base segment 204 is formed by bending high tensile rod so that the outer edge 205 forms a right angle or 90° arc, and the internal edge 206 is bent in from one end 207 of the base segment 204 at a 90° angle, a 45° angle, and a 135° angle before intersecting with the other end 208. The overall size of the base segment 204 may vary depending on the specifications of the customer. In the preferred embodiment, the outer edge 205 is larger in length than the internal edge 206.

FIG. 2 also shows a vertical member 209. In this embodiment, the vertical member 209 is characterized by two vertical sides 210, 211, base attachment portions 212, 213 and top a section portion 214. The two vertical sides 210, 211 are on opposing sides of the top section portion 214. Base attachment portions 212, 213 are formed by bending the vertical member 209 on each vertical side 210, 211 at a 90° to 95° angle. The base attachment portions 212, 213 on opposing vertical sides 210, 211 are directed away from each other. The top section portion 214 is formed between the two vertical sides 210, 211 by bending the vertical member 209 at a 90° to 120° angle on both vertical sides 210, 211. The top section portion 214 may be formed into various shapes or designs between the two sides 210, 211 depending on the specific characteristics required by the consumer. In the preferred embodiment, the top section portion 214 contains a 135° bend, a 90° bend, and a 135° bend in order to form a square shape when the carrier is assembled.

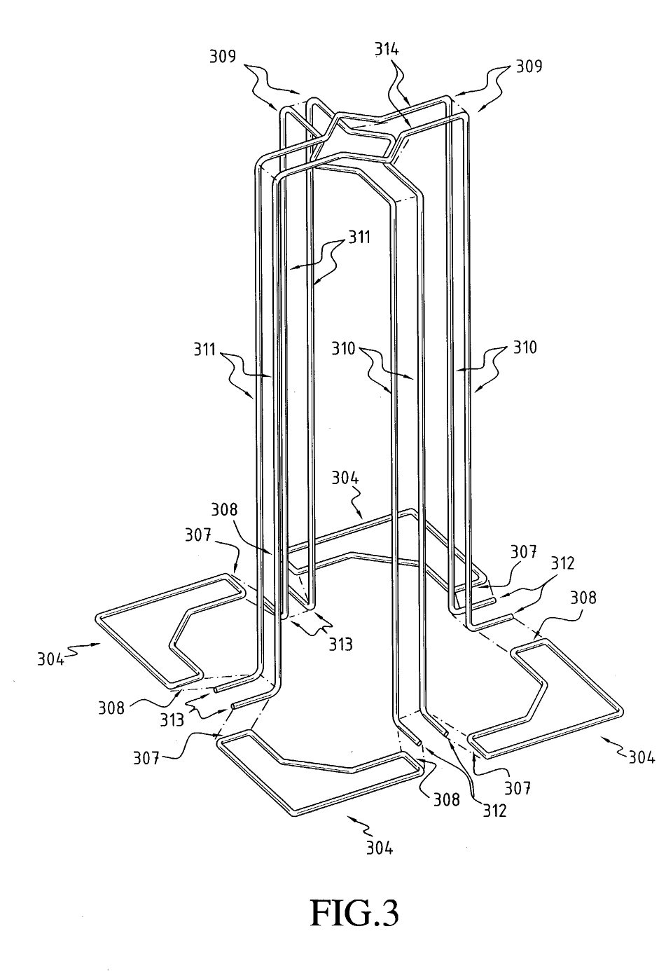

FIG. 3 shows an exploded view of the carrier. In this embodiment of the present invention, four identical vertical members 309 and four identical base members 304 are used to assemble the carrier.

Two of the identical vertical members 309 are located parallel and adjacent to each other so that vertical sides 310, 311 and base attachment portions 312, 313 are joined together to form double vertical members. If top section portion 314 includes a shape or design, vertical members 309 may be arranged so that the shape or design is exactly opposite to its companion on the adjacent vertical member 309. In the case of the preferred embodiment, two identical vertical members 309 with top sections 314, each containing a 135° bend, a 90° bend, and a 135° bend, are aligned with the bent portions of top section portions 314 directed away from each other. In this embodiment, the joining of the two vertical members 309 forms an individual square between the two top sections 314. The remaining two identical vertical members are aligned in the same way to form double vertical members, with double vertical sides, double base attachment portions, and double top section portions except where single squares are formed in the middle of each double top section portion. The resulting two double vertical members are arranged where one double vertical member is placed on top of the other double vertical member at a perpendicular angle where the double vertical members are aligned so that a double square is formed in the top section of the carrier.

The sectional or integral base of the carrier in this embodiment is arranged as the adjoining ends 307, 308 of the base segments 304 are located adjacent to the double base attachment portions, where each base segment 304 is individually located between two double base attachment portions. Depending on the shapes of the outer edges 305 of the individual base segments 304 the sectional or integral base may have a number of different shapes or designs. The preferred shapes for the outer edge of the sectional or integral base are a square or circle.

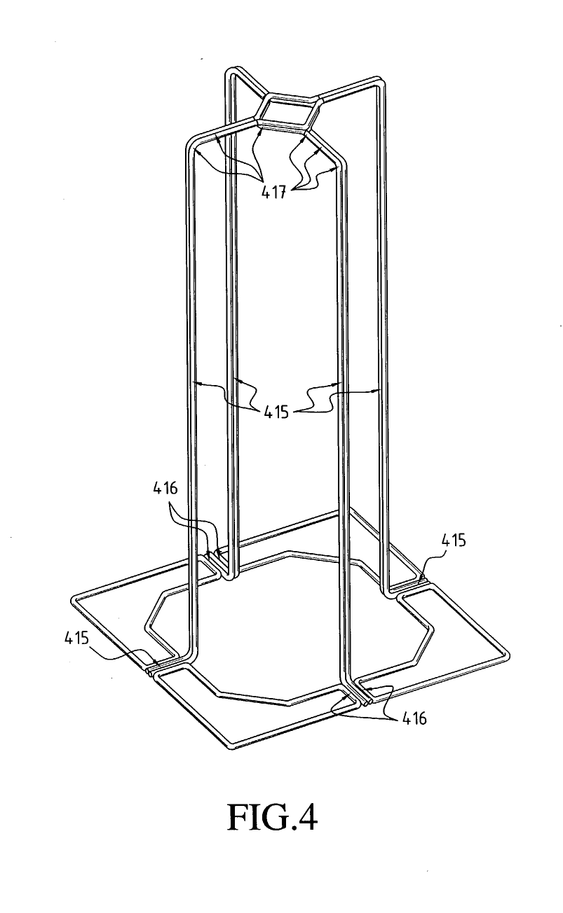

FIG. 4 shows the joining of the assembled components. The assembled carrier is held together by joining the components at the intersections 415 of identical vertical members, the intersections 416 of the adjoining ends of base segments and double base attachment portions, and the intersections 417 of top section portions with each other and the double square. The method of joining the components is contingent on the particular materials used to construct the carrier. In the preferred embodiment, the carrier is formed from high tensile rod, and the components are welded together at the points previously mentioned.

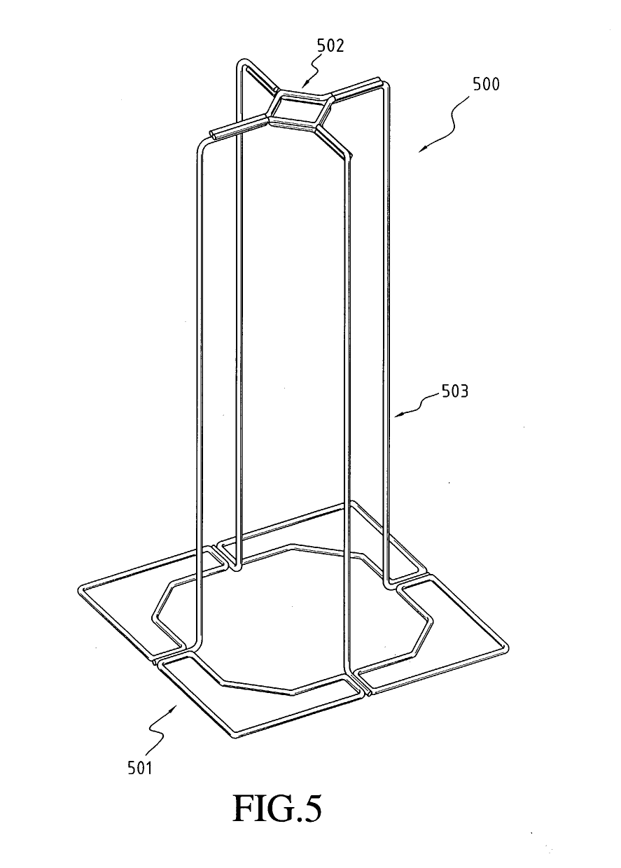

FIG. 5 shows a carrier 500 according to another embodiment of the invention. The carrier 500 includes a sectional or integral base 501 and a top section 502. The vertical area 503 of the carrier 500 is located between the base 501 and top section 502. The carrier 500 may be formed of any number of suitable materials, however the most preferred material is high tensile rod.

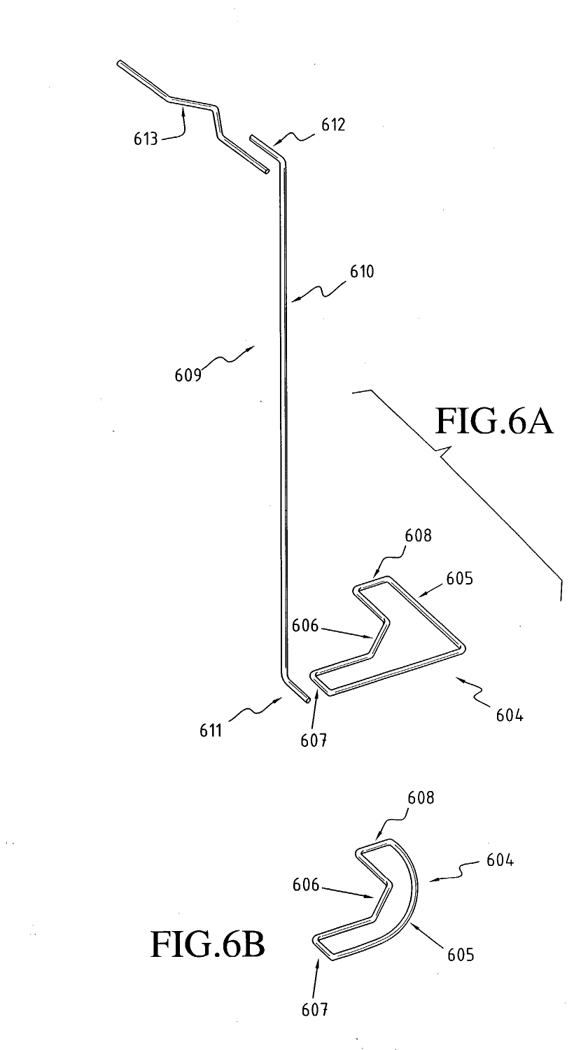

FIG. 6 shows one embodiment of the different components that may be used to construct the lightweight carrier. The sectional base is fored from a plurality of sectional independent segments 604, which may be identical or similar in shape. Base segments 604 are characterized by an outer edge 605, and internal edge 606 and two adjoining ends 607, 608. The outer edge 605 may form a right angle (FIG. 6A) or have varying curvature (FIG. 6B) from one end 607 to the other end 608. The internal edge 606 may also be characterized by a number of different designs. In the preferred embodiment, the base segment 604 is formed by bending high-tensile rod so that the outer edge 605 forms a right angle or 90° arc, and the internal edge 606 is bent in from one end 607 at a 90° angle, a 45° angle, and a 135° angle before intersecting with the other end 508 of the base segment 604. The overall size of the base member 604 may vary depending the specifications of the customer. In the preferred embodiment the outer edge 605 is larger in length than the internal edge 606.

FIG. 6 also shows vertical member 609, another component of the carrier. In this embodiment, the vertical member 609 is characterized by a vertical side 610, base attachment portion 611 and top section attachment portion 612. Base attachment portion 611 is formed by bending vertical member 509 90° to 95°. Top section attachment portion 612 is formed by bending the vertical member 509 90° to 120°.

A third component shown in FIG. 6 is a top section member 613. The top section member 613 may be formed into various shapes or designs depending on the specifications required by the consumer. In the preferred embodiment, the top section member 613 contains a 135° bend, a 90° bend, and a 135° bend in order to form a square shape when the carrier is assembled.

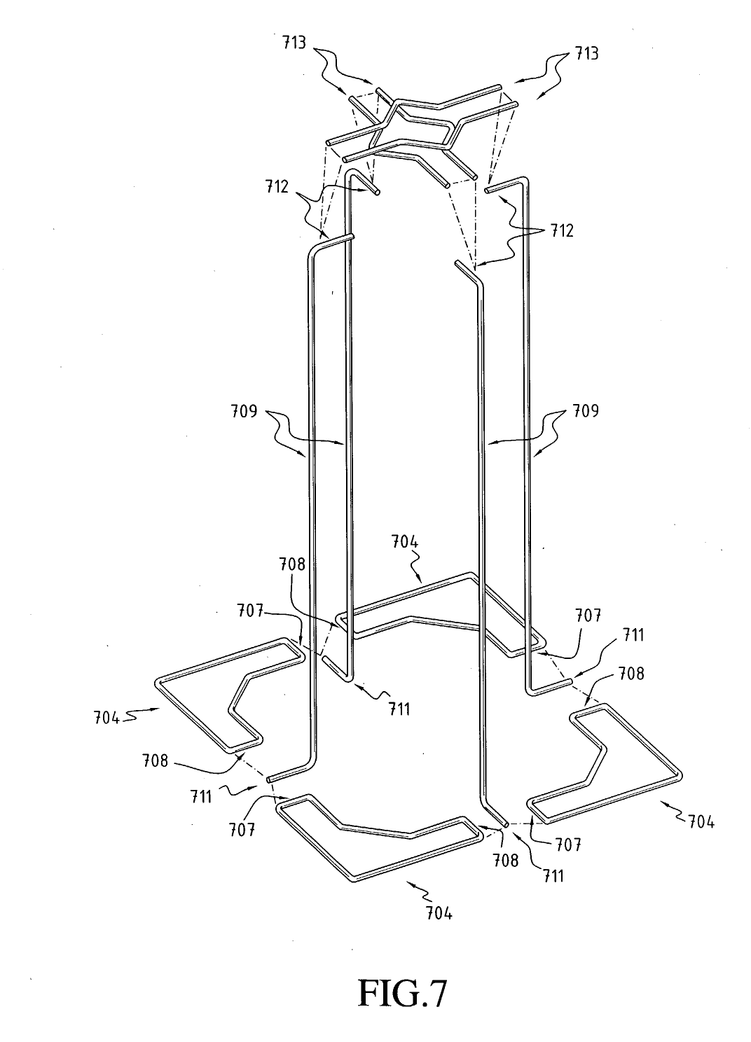

FIG. 7 shows the placement of the components when assembling the carrier. In this embodiment of the present invention, four identical vertical members 709, four identical sectional independent base segments 704, and four identical top section members 713 are assembled into the carrier.

The four base segments 704 are arranged with adjoining ends 707, 708 parallel to one another. The outer edges 705 of the base segments 704 form the outer edge of the sectional or integral base of the carrier. In the preferred embodiment, base attachment portions 711 of the four vertical members 709 are each located at a juncture of adjoining ends 707, 708, between pairs of base segments 704. In this alignment, pairs of vertical members 709 are located on opposite sides of the sectional base so that their base attachment portions 711 are directed away from each other and the top section attachment portions 712 of each vertical member 709 are directed towards each other. Four top section members 713 span between the top section attachment portions 712 of two opposing vertical members 709. If top section members 713 are bent in order to produce a particular shape or design, top section members 713 may be aligned so that the bent portions are directed away from each other, so that two top section members 713 span between two top section attachment portions 712 of opposing vertical members 709 and form a design in the top section of the carrier. In the preferred embodiment a total of four top section members 713 form a double square at the top section of the carrier.

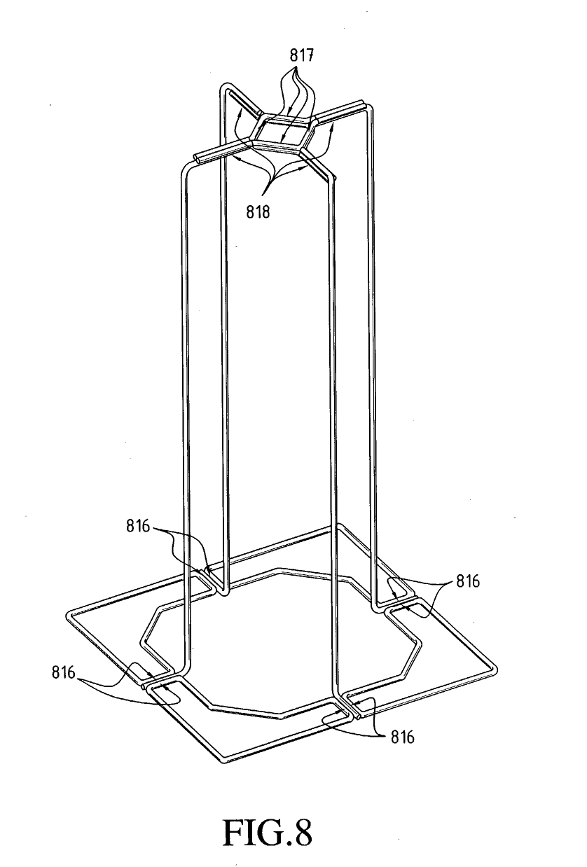

FIG. 8 shows the joining of the components of the assembled carrier. In particular, the components are joined at the intersection 816 of the base attachment portions and the adjoining ends of the base segments, the intersection 817 of the four top section members 713 with each other, and the intersection 818 of the top section attachment portions and the top section members. The method of joining the components is contingent on the particular materials used to construct the carrier. In the preferred embodiment, the carrier is formed from high tensile rod, and the components are welded together at the points previously mentioned.

The more particular specifications of the various possible embodiments of the present invention are related to the desired weight capacity and size of the carrier. These particular specifications are illustrated in the following examples:

### EXAMPLE 1

The following shows an example of a carrier with weight carrying capacity of 3,000 lbs. For this carrier, ½″ high tensile rod is used for the vertical area, top section, and base of the carrier.

### EXAMPLE 2

The following shows an example of a carrier with weight carrying capacity of 2,000 lbs. For this carrier, ½″ high tensile rod is used for the vertical area and the top section, while ⅜″ high tensile rod is used for the base.

### EXAMPLE 3

The following shows an example of a carrier with weight carrying capacity of 1,000 lbs. For this carrier, ⅜″ high tensile rod is sued for the vertical area, top section, and base of the carrier. In the case of all three examples, the vertical area, top section, and base of the carrier may vary in relation to length, height, and area according to desired specifications.

Although the present invention has been described in detail with particular reference to preferred embodiments thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A carrier for holding and transporting wound material, comprising:
a base for placement on a flat surface having a center and defined by at least four sectional independent segments, the segments joined at least at four points that are approximately 90 degrees from the center of the base; and
at least four vertical members extending from the base and joined to the base at the four points.

2. The carrier of claim 1, wherein each sectional independent segment comprises an outer edge and an internal edge extending from the outer edge toward the center; wherein the segments are joined to form the base at their internal edges.

3. The carrier of claim 1, wherein the vertical members extend from the base at 85° to 95° angles from said base.

4. The carrier of claim 1, wherein the carrier is constructed of high tensile rod.

5. The carrier of claim 4, wherein the high tensile rod is ½ to 1/4 inches in diameter.

6. A carrier for holding and transporting wound material, comprising:
a base for placement on a flat surface having a center and outer edges defined by sectional independent segments, each segment having an outer edge and an internal edge extending from the outer edge toward the center; and
at least two vertical members joined to the base;
wherein the segments are joined to form the base at their internal edges.

7. The carrier of claim 6, wherein the number of sectional independent segments is three.

8. The carrier of claim 6, wherein the number of sectional independent segments is four.

9. The carrier of claim 6, wherein the number of vertical members is three.

10. The carrier of claim 9, wherein the vertical members are joined to the base where the segments are joined to form the base.

11. The carrier of claim 6, wherein the number of vertical members is four.

12. The carrier of claim 11, wherein the vertical members are joined to the base where the segments are joined to form the base.

13. The carrier of claim 12, wherein the vertical members are joined to the base at 90° angles from the center of the base.

14. The carrier of claim 6, wherein the vertical members are joined to the base at 90° angles from the center of the base.

15. The carrier of claim 6 wherein the carrier is constructed from high tensile rod.

16. The carrier of claim 15 where the high-tensile rod is ½ to 1/4 inches in diameter.

17. A carrier for holding and transporting wound material, comprising:
a base for placement on a flat surface having a center and outer edges defined by at least four sectional independent segments, each segment having an outer edge and an internal edge extending from the outer edge toward said center, wherein the segments are joined at least at four points that are approximately 90° from the center of the base; and
at least two vertical members extending from the base and joined to the base at the four points.
